(19) United States
(12) Patent Application Publication
(10) Pub. No.: US 2026/0186843 A1
(43) Pub. Date: Jul. 2, 2026

(54) FLEXIBLE EDGE COMPUTING AND DATA CENTER MESH NETWORK FOR OPTIMIZING COMPUTATIONAL AND ENERGY EFFICIENCY UTILIZING AVAILABLE PROCESSING RESOURCES

(71) Applicant: EnnoFlow Technologies Inc., Round Rock, TX (US)

(72) Inventor: Ignacio Juarez, Round Rock, TX (US)

(21) Appl. No.: 19/431,196

(22) Filed: Dec. 23, 2025

Related U.S. Application Data
(60) Provisional application No. 63/739,392, filed on Dec. 27, 2024.

(51) Int. Cl. G06F 9/50; G06F 1/3234

(52) U.S. Cl. CPC G06F 9/5027; G06F 1/3234

(57) ABSTRACT

Systems and methods for flexible edge computing are provided that include a central controller communicatively coupled to a plurality of processor nodes forming a distributed compute mesh, wherein the central controller includes a memory storing edge computing algorithms which, when executed, cause the central controller to perform operations comprising receiving, in real-time, task data characterizing compute workloads from a compute client, energy data characterizing local energy availability and pricing proximate the processor nodes, and compute market pricing data, determining a predicted profitability and predicted operational suitability associated with executing the one or more compute workloads at each of the plurality of processor nodes based on the task data, the energy data, the compute data, and routing the one or more compute workloads to one or more of the plurality of processor nodes having a highest predicted profitability or highest predicted operational suitability.

### CROSS-REFERENCE TO RELATED APPLICATIONS

This application claims priority under 35 U.S.C. § 119(e) to U.S. Provisional Application No. 63/739,392, filed December 27, 2024, and titled “FLEXIBLE EDGE COMPUTING MESH NETWORK UTILIZING AVALIABLE PROCESSING RESOURCES FOR OPTIMIZED COMPUTATIONAL AND ENERGY EFFICIENCY,” the contents of which are incorporated by reference herewith in their entirety.

### FIELD OF INVENTION

The present disclosure relates to energy management systems, and more particularly flexible edge computing and data center mesh networks that utilize available processing resources to optimize computational and energy efficiency.

### BACKGROUND

Conventional hyperscale cloud infrastructures have been developed to address growing computational demands, but these systems require massive capital investment and consume substantial electricity and water resources. These centralized facilities are also limited by network latency, data sovereignty rules, transmission bottlenecks, and general geographical separation between data centers. Additionally, the growing scale of renewable generation introduces variability, intermittency, and congestion challenges that may affect the reliability and efficiency of such centralized approaches.

Existing computational and energy management resources operate in silos. Data center infrastructures typically optimize compute workloads independent of local energy conditions, potentially missing opportunities to leverage favorable energy availability or pricing. Distributed energy management platforms focus on optimizing energy resources without considering how compute capacity might be monetized or coordinated with energy availability. Blockchain-based and decentralized compute platforms lack energy awareness and cannot guarantee reliable availability, as these systems often do not account for the energy constraints or opportunities present at participating nodes. These siloed approaches may result in inefficiencies and missed opportunities for coordinated optimization across both computational and energy domains.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one aspect, a system is provided that can include a central controller communicatively coupled to a plurality of processor nodes forming a distributed compute mesh. The central controller can include a memory storing a plurality of edge computing algorithms which, when executed by the central controller, cause the central controller to perform operations. The operations can include receiving, in real-time, task data characterizing one or more compute workloads from a compute client. The operations can include receiving, in real-time, energy data characterizing local energy availability and energy pricing proximate the plurality of processor nodes and compute market pricing data characterizing compute market pricing proximate the plurality of processor nodes. The operations can include determining a predicted profitability and predicted operational suitability associated with executing the one or more compute workloads at each of the plurality of processor nodes based on the task data, the energy data, and the compute data. The operations can include routing the one or more compute workloads to one or more of the plurality of processor nodes having a highest predicted profitability or highest predicted operational suitability.

In some aspects, the central controller can be cloud based. In some aspects, the central controller can further include a cloud-based component and one or more local controller components provided proximate to each of the plurality of processor nodes.

In some aspects, each local controller component can be arranged to determine the predicted profitability and predicted operational suitability associated with executing the one or more compute workloads by a processor node of the plurality of processor nodes proximate the local controller component based on the task data, the energy data, and the compute data.

In some aspects, each local controller component can be further arranged to reject the one or more compute workloads responsive to the determining that the predicted profitability is negative or that the processor node proximate the local controller component does not have sufficient capacity.

In some aspects, each local controller component can be further arranged to migrate the one or more compute workloads, by the prioritization algorithm, to another processor node of the plurality of processor nodes responsive to determining that the other processor node exhibits a higher predicted profitability or has sufficient capacity.

In some aspects, each local controller component can be further arranged to generate a set of priority rules for routing the one or more compute workloads, wherein the set of priority rules can be generated based on the task data, the energy data, the compute data, performance of the processor node, and the predicted profitability and predicted operational suitability. Each local controller component can be further arranged to update the set of priority rules dynamically based on observed execution performance by the processor node, a realized profitability, and a realized operational suitability.

In some aspects, each local controller component can be further arranged to autonomously suspend exposure to the one or more compute workloads responsive to a local reliability condition, an energy scarcity event, or a grid flexibility signal. Suspended workloads can be resumed when local or system-wide energy conditions improve.

In some aspects, the processor node proximate each local controller component can be arranged to store the one or more compute workloads in a queue for later execution during periods of limited communication connectivity or capacity.

In some aspects, each local controller component can be further arranged to receive attestation results from a secure enrollment mechanism of the processor node proximate the local controller component. Each local controller component can be further arranged to generate trust evaluations for the processor node based on the attestation results. Each local controller component can be further arranged to restrict or enhance future workload assignment to the processor node based on the trust evaluations.

In some aspects, each local controller component can be further arranged to restrict or enhance future workload assignment to the processor node based on a capacity of the processor node.

In some aspects, each local controller component can be further arranged to dynamically switch a state of the processor node proximate the local controller component between an active state in which the processor node can be arranged to execute the one or more compute tasks, an offloading state in which the processor node can be arranged to offload the one or more compute workloads, and an inactive state in which the processor node can be withdrawn from the distributed compute mesh.

In some aspects, the task data can be received from the compute client, via an external market interface.

In some aspects, the plurality of processor nodes can be aggregated into a unified compute pool that can be exposed to external compute markets via the external market interface, enabling the distributed compute mesh to operate as a virtual distributed data center accessible to compute clients.

In some aspects, each local controller component can be further arranged to receive processed compute workloads from the processor node proximate the local controller component. Each local controller component can be further arranged to verify the processed compute workloads for accuracy and integrity. Each local controller component can be further arranged to provide training data to the plurality of edge computing algorithms, wherein the training data characterizes at least one of observed execution performance, realized profitability, and realized operational suitability associated with the processed compute workloads. Each local controller component can be further arranged to provide the processed compute workloads to the compute client.

In some aspects, the central processor can be further arranged to distribute compute-related compensation to owners of the plurality of processor nodes and operational partners based on the processed compute workloads.

In some aspects, the plurality of processor nodes can include any of CPUs, GPUs, neural accelerators, electric vehicle onboard compute systems, edge servers, IoT compute devices, and quantum accelerators.

In some aspects, the task data can further include data characterizing service level agreements (SLAs) for the one or more compute workloads.

In some aspects, the central controller can be arranged to perform operations further including determining whether the one or more compute workloads should be executed using one or more of the plurality of processor nodes based on at least one of the task data, the energy data, the compute data, a capacity of the plurality of processor nodes, performance metrics of the plurality of processor nodes, and thermal conditions of the plurality of processor nodes.

In some aspects, the task data can further include workload classification data characterizing whether the one or more compute workloads can be either time-critical or opportunistic. The central controller can be arranged to determine whether the one or more compute workloads should be executed using one or more of the plurality of processor nodes based on the workload classification data.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a diagram illustrating an exemplary system adapted to execute flexible edge computing and energy management using one or more disparate processing resources that together form a distributed computing mesh, according to aspects of the present disclosure;

FIG. 1A is a diagram illustrating the components and algorithms associated with an exemplary orchestration core of FIG. 1, according to aspects of the present disclosure;

FIG. 2 is a flow diagram illustrating an exemplary grid-responsive participation workflow performed by the orchestration core of FIG. 1;

FIG. 3 is a flow diagram illustrating an exemplary enrollment process for processor nodes within the distributed compute mesh of FIG. 1A, according to aspects of the present disclosure;

FIG. 4 is a diagram illustrating an exemplary distributed trust and attestation system for the distributed compute mesh of FIG. 1A, according to aspects of the present disclosure;

FIG. 5 is a flow diagram illustrating an exemplary task execution workflow performed by the core of FIG. 1A, according to aspects of the present disclosure;

FIG. 6 is a flow diagram illustrating an exemplary workload classification, prioritization, and routing process within the distributed compute mesh of FIG. 1A, according to aspects of the present disclosure;

FIG. 7 is a flow diagram illustrating an exemplary workload prioritization and decision process within the orchestration core of FIG. 1A, according to aspects of the present disclosure;

FIG. 8 is a diagram illustrating an exemplary role-switching and workload migration system within the distributed compute mesh of FIG. 1A, according to aspects of the present disclosure;

FIG. 9 is a flow diagram illustrating an exemplary compute revenue accumulation algorithm for the system of FIG. 1A, according to aspects of the present disclosure; and

FIG. 10 is a diagram illustrating a process of operating an aggregated compute pool of processor nodes according to aspects of the present disclosure.

### DETAILED DESCRIPTION

The demand for computational power continues to grow exponentially due to artificial intelligence, large-scale simulation, rendering, machine learning inference, decentralized services, and real-time analytics. Conventional hyperscale cloud infrastructures require massive capital investment, consume substantial electricity and water, and are limited by physical distance, network latency, data sovereignty rules, and transmission bottlenecks. AI adoption and chip shortages may further constrain centralized compute supply and increase processing costs. In parallel, a vast amount of deployed compute hardware remains idle or underutilized across homes, commercial buildings, factories, vehicles, mobile devices, automation systems, and research environments. Examples include CPUs in laptops and desktops, GPUs in gaming computers and electric vehicles, neural processing units in smartphones and IoT devices, and accelerators in automation equipment.

Edge computing aims to reduce latency and optimize bandwidth by processing data closer to its source. However, existing edge systems may operate as silos: they may not leverage the combined resources of distributed devices, may not monetize idle compute capacity, and may not dynamically adapt participation based on economic or physical conditions. In some cases, these systems lack secure enrollment, workload attestation, or trust frameworks that may be used to form persistent compute networks. On the energy side, the growing scale of renewable generation introduces variability, intermittency, and congestion challenges. Distributed energy resources (DERs), including solar, batteries, and electric vehicles, increasingly provide grid flexibility, but current energy platforms may treat compute loads as rigid and may not monetize compute flexibility as a grid service.

At present, data center infrastructures may optimize compute only, independent of local energy conditions. Distributed energy management platforms may optimize energy only, without considering compute monetization. Blockchain-based and decentralized compute platforms may lack energy awareness and may not guarantee reliable availability. These siloed approaches may result in inefficiencies and missed opportunities for coordinated optimization.

Accordingly, there is a need for an architecture that treats distributed processors as dispatchable compute assets participating in compute markets, enables real-time participation based on physical and economic signals, provides secure onboarding and attestation of compute workloads, integrates compute monetization with DERs and EV charging behavior, forms a virtual distributed data center that is flexible, self-balancing, and resilient, and provides reliable fallback operation during communications outages.

The present disclosure provides a system and method for establishing a flexible edge computing mesh network by leveraging the underutilized processing resources of distributed devices and coordinating them with distributed energy resources and electrical grid signals to optimize power consumption, operational cost, device health, and economic incentives. These devices may include personal computers, smartphones, IoT devices, smart appliances, electric vehicles, quantum accelerators, and other specialized hardware in residential, commercial, mobile, or industrial deployments. The system may monetize idle and underutilized processors across the mesh to form a distributed compute marketplace. This compute monetization may allow devices to generate revenue by executing compute tasks when doing so is profitable, energy-efficient, or grid-supportive. The distributed energy resources may include, but are not limited to, solar photovoltaic installations, wind turbines, gas generators, stationary batteries, EV charging infrastructure, and controllable loads.

The system may dynamically select workloads based on profitability, energy availability, carbon intensity, network constraints, local reliability conditions, and lifecycle considerations including capital-expense recovery. The system may create a dual-market optimization mechanism in which nodes participate in both compute and energy transactive systems. In some aspects, the system provides a flexible distributed compute mesh where any processor, regardless of type or ownership, may join securely, provide compute services, and earn revenue; leave automatically when energy or profitability conditions degrade; react to local and system-wide conditions in real time; and continue execution even during communication interruptions.

In some aspects, the system includes processor-agnostic federation through trusted enrollment and attestation of heterogeneous processors, including CPUs, GPUs, NPUs, ASICs, FPGAs, quantum accelerators, and EV onboard computers. The system may include prioritization-based orchestration where workloads are routed to processors that provide an optimal blend of energy cost, renewable availability, profitability, latency, reliability, thermal state, and user preferences. The system may migrate or suspend workloads based on dynamic network, market, and physical signals. The mesh may behave as a secure, software-defined data center that aggregates distributed compute resources and executes workloads including inference, rendering, simulation, and batch processing. Examples of the architecture which can be used to execute the functionalities described herein can be found in U.S. Patent Application 19/334,814, the entire contents of which are incorporated herein by reference.

In some aspects, idle compute becomes a dispatchable asset that generates revenue. Earnings may be allocated among the device owner, an orchestration provider, and grid or market operators to incentivize flexible participation. During reliability events or during high-price or carbon-intensive periods, compute execution may be curtailed, enabling devices to provide demand flexibility and grid services. Tasks may resume automatically when conditions improve. Machine-learning decision engines may compare predicted versus observed performance to improve workload placement and economic returns over time. In the absence of wide-area communications, local decision logic may preserve processing and grid-responsive behavior until synchronization is restored.

Advantages of the disclosed architecture may include computational efficiency through maximizing utilization of existing hardware and avoiding overbuilding centralized infrastructure. Energy efficiency may be achieved by aligning compute workloads with energy availability, price, and carbon intensity. Cost savings may result from reducing operating costs by shifting workloads to cheaper or more efficient locations. Environmental impact may be reduced by leveraging renewable energy and reducing reliance on energy-intensive data centers. Scalability and flexibility may be supported through dynamic, heterogeneous, and intermittent node participation. Security may be enhanced by reducing single points of failure and employing distributed attestation and runtime verification. Grid support and stability may be provided through a new class of flexible load using compute as a controllable resource.

The following description sets forth exemplary aspects of the present disclosure. It should be recognized, however, that such description is not intended as a limitation on the scope of the present disclosure. Rather, the description also encompasses combinations and modifications to those exemplary aspects described herein.

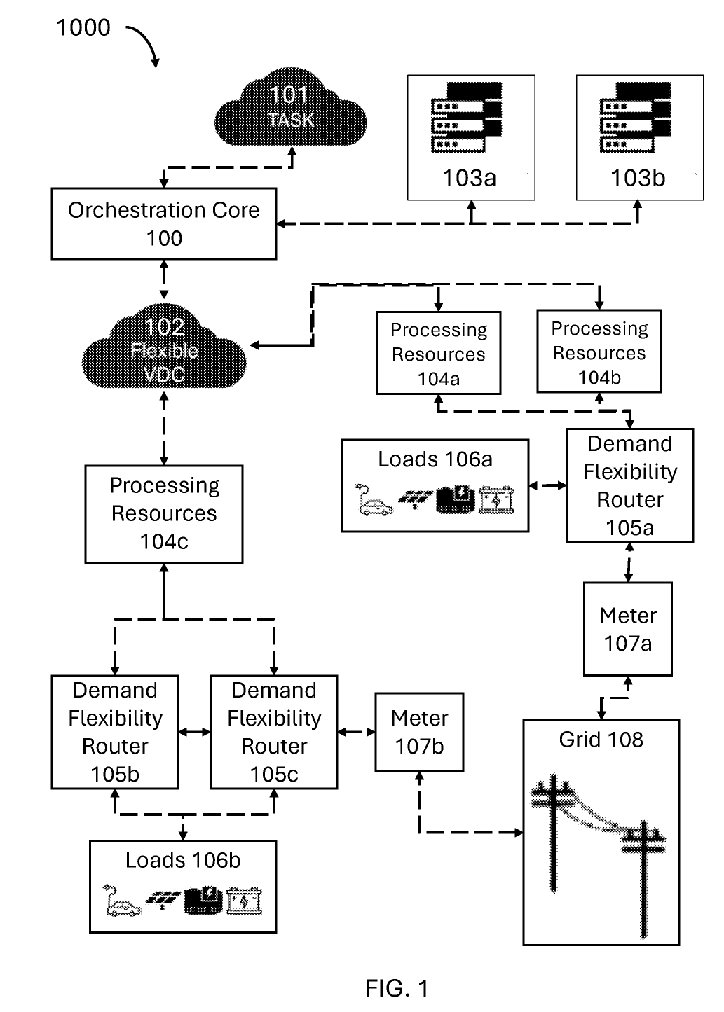

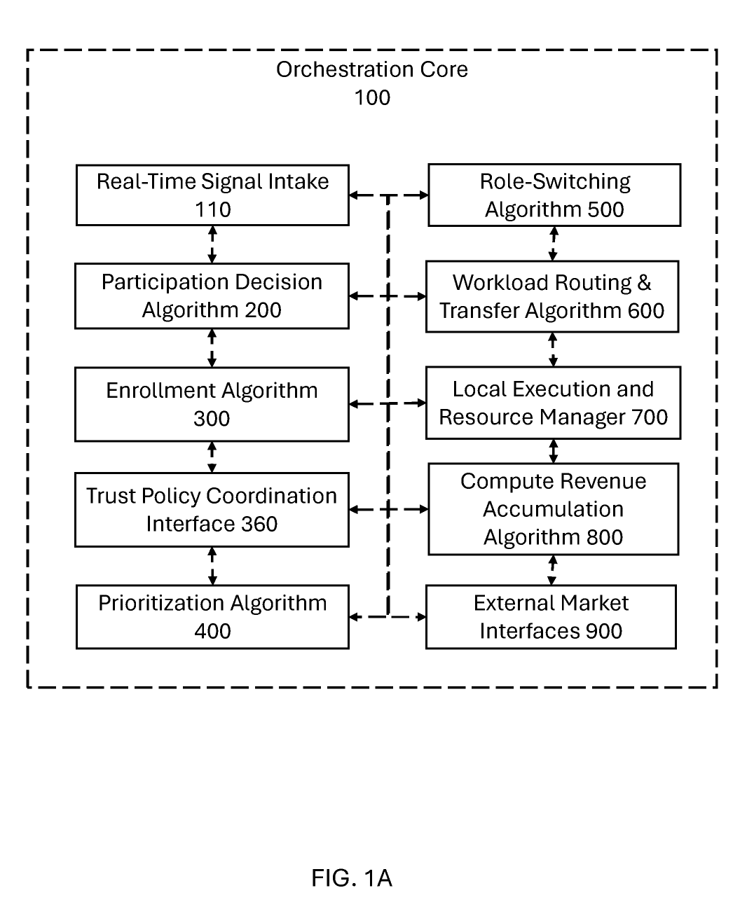

FIG. 1 is a diagram illustrating an exemplary system 1000 for flexible edge computing and energy management. As shown, the system 1000 includes a workload and energy orchestration core 100 (also referred to herein as a central controller) that receives a task 101 from a compute client. In some aspects, the compute client can be, for example, companies that require compute tasks to be executed. Such companies can include, but are not limited to, physical data centers; artificial intelligence and machine learning firms; cloud service providers; high-performance computing organizations engaged in scientific simulations, weather forecasting, complex data analysis, etc.; financial institutions; media and entertainment companies; healthcare and genomics businesses; autonomous vehicle and robotics developers; large-scale e-commerce platforms and social media networks; general-purpose GPU/CPU workload providers that seek to offload computational tasks; and more. The workload and energy orchestration core 100 includes a memory storing a plurality of edge computing algorithms which, when executed by the workload and energy orchestration core 100, cause the workload and energy orchestration core 100 to perform operations including receiving, in real-time, task data characterizing one or more compute workloads from the compute client. The workload and energy orchestration core 100 is communicatively coupled to a flexible virtual data center (VDC) 102 (also referred to herein as a distributed compute mesh) and optionally to one or more physical data centers 103a, 103b, which can be adapted to provide conventional centralized computing resources.

With continued reference to FIG. 1, the flexible VDC 102 is communicatively coupled to a plurality of processor nodes within the distributed compute mesh, which are depicted as processing resources 104a, 104b, and 104c. The processing resources 104a, 104b, and 104c may be a variety of different types of processing resources which can include, but ais not limited to CPUs, GPUs, neural processing units/accelerators (NPUs), electric vehicle (EV) onboard compute systems, edge servers, IoT compute devices, quantum accelerators, ASICs, FPGAs, consumer electronics such as smartphones, laptops, smart appliances, and gaming consoles, as well as industrial controllers and gateway devices.

In some aspects, the workload and energy orchestration core 100 may implemented in a centralized computing environment, a distributed computing environment, at one or more edge devices, or in a hybrid configuration combining cloud-based and edge-resident components. For example, in some aspects, the system 1000 further includes one or more demand flexibility routers 105a, 105b, 105c, which can also be referred to herein as local controller components of the workload and energy orchestration core 100. Accordingly, in some cases, the workload and energy orchestration core 100 may be partially cloud-based and partially provided on edge devices, such as the demand flexibility routers 105a, 105b, and 105c and/or within the processing resources 104a, 104b, and 104c themselves.

The demand flexibility routers 105a-105c can be hardware routers that are installed at locations proximate to and associated with the processing resources 104a-104c. In some aspects, the demand flexibility routers 105a, 105b, and 105c can be installed at the edge, at residences, industrial plants, commercial facilities, public facilities, research facilities, etc., and can be adapted to manage local loads 106a, 106b provided at the facilities. For example, in a case where the one of the demand flexibility routers 105a-105c is installed at a residence, the loads 106a, 106b may include a variety of distributed energy resources (DERs) including, but not limited to, rooftop photovoltaic solar installations, generators, battery storage systems (e.g., EV batteries), heat pump systems, and smart appliances within the residence, etc. The demand flexibility routers 105a-105c can be installed between a meter 107a, 107b of the facility and a grid 108, to effectively enable energy management and grid interaction. For example, in some aspects, the demand flexibility routers 105a, 105b, and 105c may have similar architecture and functionality to the energy orchestration routers described in U.S. Patent Application No. 19/334,814, the entire contents of which are expressly incorporated by reference herein in its entirety.

In operation, the workload and energy orchestration core 100 and/or the demand flexibility routers/local controller components 105a, 105b, 105c can be adapted to receive the task 101 from the compute client, along with local energy and compute pricing data, and leverage a plurality of edge computing algorithms to determine the availability of the processing resources 104a, 104b, and 104c within the flexible VDC 102, the viability of executing the task 101, and route the task 101 to one or more of the processing resources 104a, 104b, and 104c for execution, as discussed in greater detail below. In some cases, if the flexible VDC 102 is unavailable, or economics associated with executing the task 101 are not favorable, then the workload and energy orchestration core 100 may coordinate with the physical data center 103a and the physical data center 103b to execute the task 101 in a traditional manner. The system 1000 may operate as a bidirectional compute load balancer for centralized data centers. For example, during periods of high PUE (Power Usage Effectiveness) or expensive grid conditions, workloads (e.g., tasks 101) can be are offloaded to the distributed mesh (e.g., flexible VDC 102) through External Market Interfaces, as discussed in greater detail below. When centralized capacity is underutilized, workloads may flow back to the physical data centers 103a, 103b or remain in the demand flexibility routers 105a-105c of the flexible VDC 102, depending on economic and latency considerations.

In some aspects, one or more of the processing resources 104a, 104b, and 104c may execute the task 101 using power provided by the loads 106a and 106b provided proximate to the processing resources 104a, 104b, and 104c, when available. For example, in a case where the processing resources 104a include an EV processor, the system 1000 may be adapted to power the EV processor using a battery of the EV (which would be a component of the loads 106a), if the owner of the EV is not utilizing the EV and using power from the EV battery would be economically preferable. However, in some cases, the system 1000 may be adapted to power the EV processor using energy from the grid 108 if doing so would be economically preferable.

Additionally, the system 1000 allows for the processing resources 104a, 104b, and 104c to dynamically enroll and unenroll from the mesh 102, depending on local energy and compute conditions and their individual availability. For example, the demand flexibility routers 105a, 105b, and 105c may include local grid-responsive management modules that autonomously adjust workload execution in response to voltage deviations, local congestion, cost-of-energy signals, and carbon intensity indicators. The system 1000 may increase compute execution when local renewable power is available or storage is charging and may reduce or suspend workloads when grid stress emerges. In another example, if the processing resource 104a is an EV, the EV processor may become an active compute node within the distributed compute mesh when the owner parks the EV in their garage and plugs it in to charge. The EV processor may manage execution of tasks 101 based on State of Charge (SOC), charging schedule and expected departure time, local energy prices, and local grid reliability signals. When the EV SOC is high and energy costs are low, the vehicle may increase compute participation, and with elevated price or frequency instability, participation may be reduced. The system 1000 and or the local demand flexibility router 105a provided proximate to the processing resource 104a may also be adapted to dynamically learn from the owner’s usage routines to better schedule for periods of increased and decreased participation. For example, over time, the local demand flexibility router 105a may learn that the owner tends to get home and park their EV at 8:00pm and leave in the morning at 7:00am. In this case, the local demand flexibility router 105a may learn to increase participation in the mesh 102 during the nights, between 8:00pm and 7:00am.

Overall, the system 1000 may be adapted to execute computation on behalf of compute clients during periods of low-cost or on-site renewable power. In some aspects, a plurality of processor nodes 104a, 104b, 104c may be located across residential, commercial, industrial, and mobile environments (or deployed across a single facility), and can be aggregated into a unified compute pool, which is accessible to external compute markets, as discussed below. The system 1000 may reduce execution and support demand response events coordinated through the local grid-responsive management modules during grid peaks and may provide grid support services such as frequency response, voltage support, congestion relief, or capacity reserves by adjusting compute exposure as part of a broader DER management strategy. The system 1000 may redirect power to services, resiliency functions, or safety systems during grid reliability events or local energy scarcity.

FIG. 1A is a diagram illustrating the workload and energy orchestration core 100 of FIG. 1. As shown, the core 100 includes a plurality of interconnected algorithmic components and interfaces that communicate to coordinate workload execution and energy-aware participation across the processing resources 104a, 104b, and 104c forming the distributed compute mesh. Each of the components 110-900 (described below) are communicatively coupled via the workload and energy orchestration core 100, enabling coordinated operation across the distributed compute mesh. Additionally, in some aspects, the plurality of edge computing algorithms and interfaces 110-900 may be distributed between a cloud-based component of the workload and energy orchestration core 100 and one or more local controller components provided proximate to each of the processing resources 104a, 104b, and 104c. The local controller components may include the demand flexibility routers (e.g., 105a-105c), or may be implemented within the processing resources 104a, 104b, and 104c themselves.

In some aspects, the workload and energy orchestration core 100 comprises a real-time signal intake 110. The real-time signal intake 110 receives, in real-time, energy data characterizing local energy availability and energy pricing proximate the processing resources 104a, 104b, and 104c, as well as compute market pricing data characterizing compute market pricing proximate the processing resources 104a, 104b, and 104c. The real-time signal intake 110 may receive data through communication protocols including TCP/IP, HTTP, MQTT, and gRPC, with control and data traffic protected by encryption and authentication mechanisms. The system 1000 may support transport-agnostic links including wired, Wi-Fi, cellular, satellite, powerline, or local fieldbus communications. In some aspects, the real-time signal intake 110 may include predictive analytics capabilities/forecasting algorithms that are configured to predict energy availability based on weather patterns, usage history, and grid signals. In some aspect, the real-time signal intake 110 may occur at the edge. For example, in reference to FIG. 1, the real-time signal intake 110 can occur at the local controller portions of the core 100 (e.g., the demand flexibility routers 105a, 105b, 105c). In such aspects, each of the local controller components may receive, in real-time, energy data characterizing local energy availability and energy pricing proximate the processing resources 104a, 104b, and 104c, as well as compute market pricing data, directly at the edge.

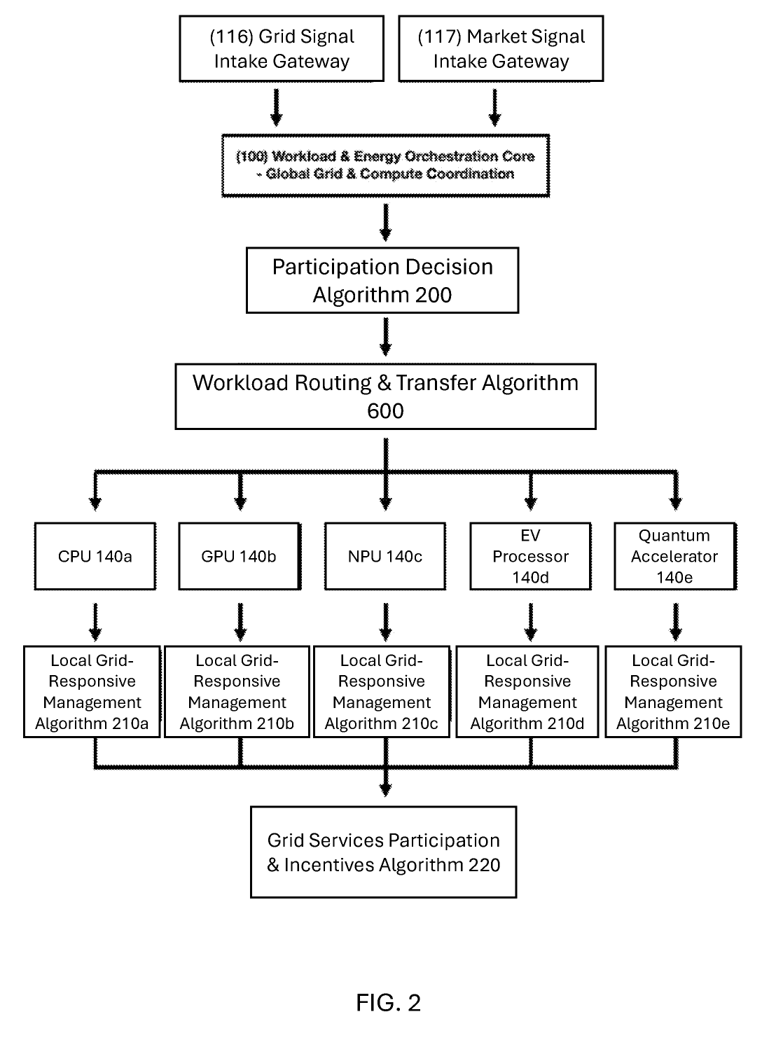

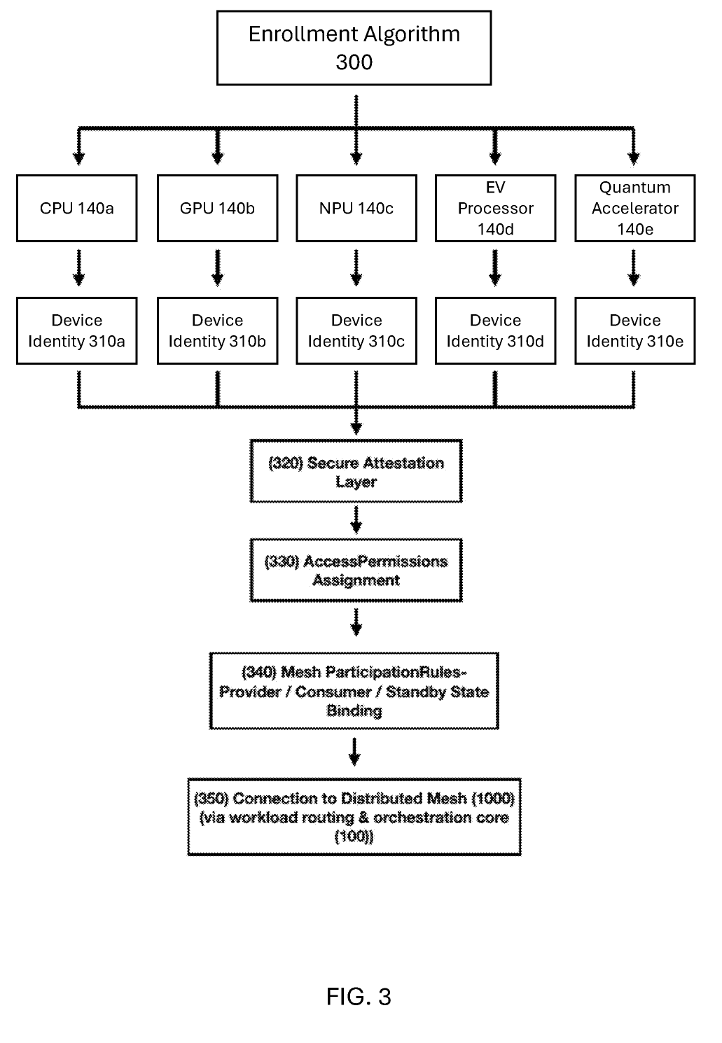

With continued reference to FIG. 1A, the workload and energy orchestration core 100 comprises a participation decision algorithm 200. The participation decision algorithm 200 receives signal data and determines whether one or more compute workloads should be executed using one or more of the processing resources 104a, 104b, and 104c based on any of: the task data, energy data, compute data, a capacity/availability of the processing resources 104a, 104b, and 104c, and performance metrics of the processing resources 104a, 104b, and 104c, as discussed in greater detail below in reference to FIGS. 2-3.

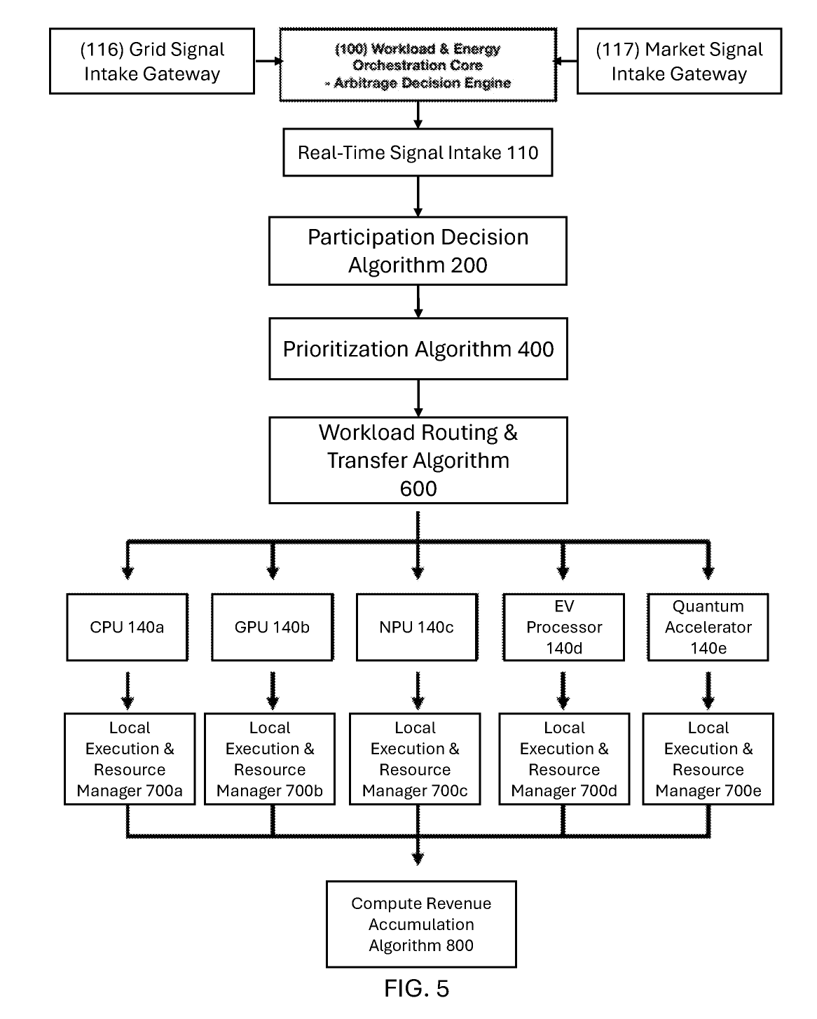

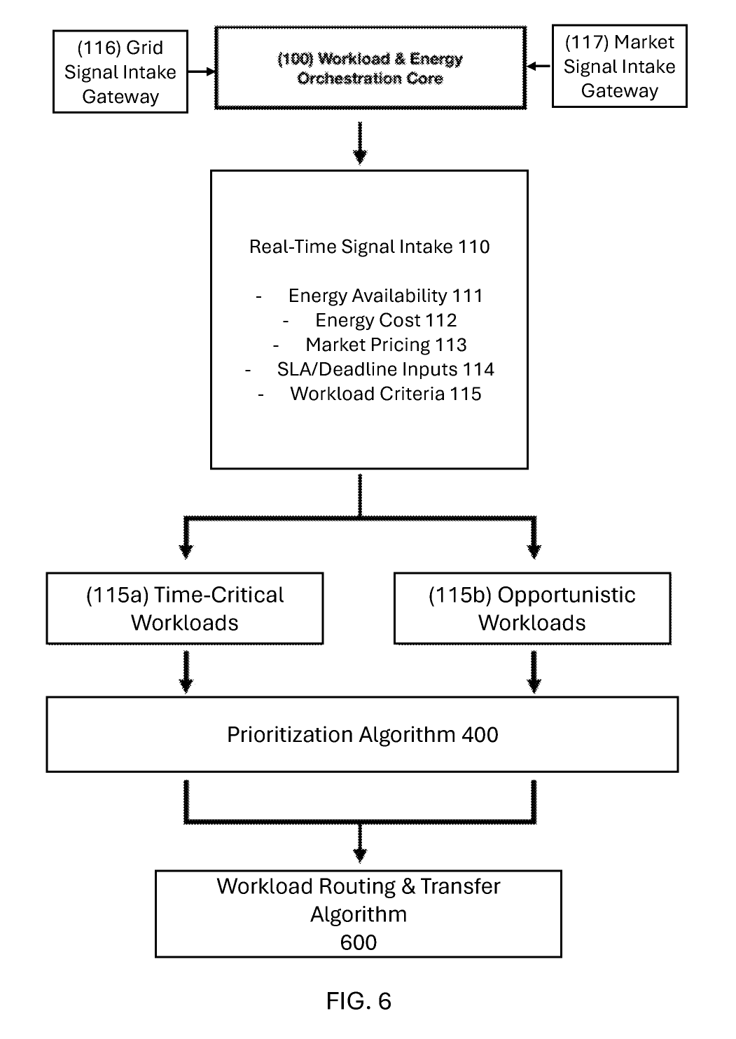

As further shown in FIG. 1A, the workload and energy orchestration core 100 comprises an enrollment algorithm 300, which handles secure onboarding and registration of processor nodes into the distributed compute mesh. The enrollment algorithm 300 may use secure identity certificates or keys associated with the plurality of processor nodes (e.g., processing resources 104a-104c) to autonomously enroll the processor nodes in the mesh, as discussed in greater detail below in reference to FIG. 5. In some aspects, the enrollment algorithm 300 may use trusted execution and hardware attestation mechanisms, optional hardware roots-of-trust, and optional reputation or scoring models to aid in the enrollment process. The core 100 can also include a trust policy coordination interface 360, which is adapted to receive attestation results from local security agents and/or secure enrollment mechanism of each processor node (e.g., software components provided on the processor nodes themselves) and generate trust evaluations for the processor node based on the attestation results. The local security agents and/or secure enrollment mechanism of each processor node are therefore used to verify execution integrity before and after workload processing and enforce safe participation within the distributed compute mesh. In some aspects, the trust policy coordination interface 360 may restrict or enhance future workload assignment to the processor node based on the trust evaluations and based on a capacity of the processor node. Local security agents associated with each processor node may exchange attestation evidence between nodes to ensure that no single trust anchor can compromise system integrity. An execution integrity feedback module may enable the workload and energy orchestration core 100 to adjust node participation, suspend compromised nodes, and reward stable nodes with more profitable workloads. The trust policy coordination interface 360 is discussed in greater detail below in reference to FIG. 6.

As further shown in FIG. 1A, the workload and energy orchestration core 100 also includes a prioritization algorithm 400, which is adapted to determine predicted profitability and predicted operational suitability associated with executing the one or more compute workloads based on task data, energy data, compute data, and conditions of the individual processor nodes. The prioritization algorithm 400 may determine whether each workload should be executed immediately when energy economics are favorable, deferred or batch-processed when conditions are temporarily unfavorable, rejected responsive to determining that the predicted profitability is negative or that the processor node(s) do not have sufficient capacity or performance capabilities, or migrated to another processor node responsive to determining that the other processor node exhibits a higher predicted profitability or has sufficient capacity. In some aspects, the prioritization algorithm 400 may be provided at the edge (e.g., within each of the demand flexibility routers 105a, 105b, 105c) and can be adapted to make decisions regarding the execution, deferral, rejection, or migration of the one or more compute workloads by the processor nodes proximate to the demand flexibility router 105a, 105b, 105c based on local conditions. For example, each local controller component may generate a set of priority rules for routing the one or more compute workloads, where the set of priority rules are generated based on the task data, energy data, computing data, performance of the processor node, and the predicted profitability and predicted operational suitability. Each local controller component may update the set of priority rules dynamically based on observed execution performance by the processor node, a realized profitability, and a realized operational suitability, as discussed below in reference to FIGS. 3-4 and 7.

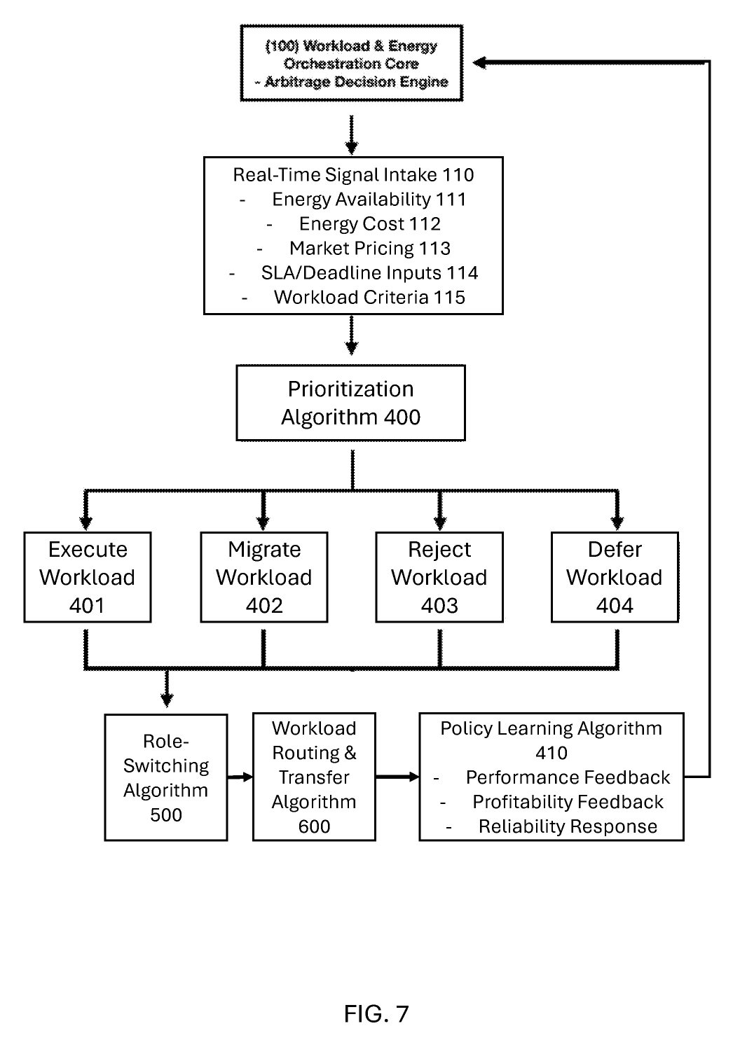

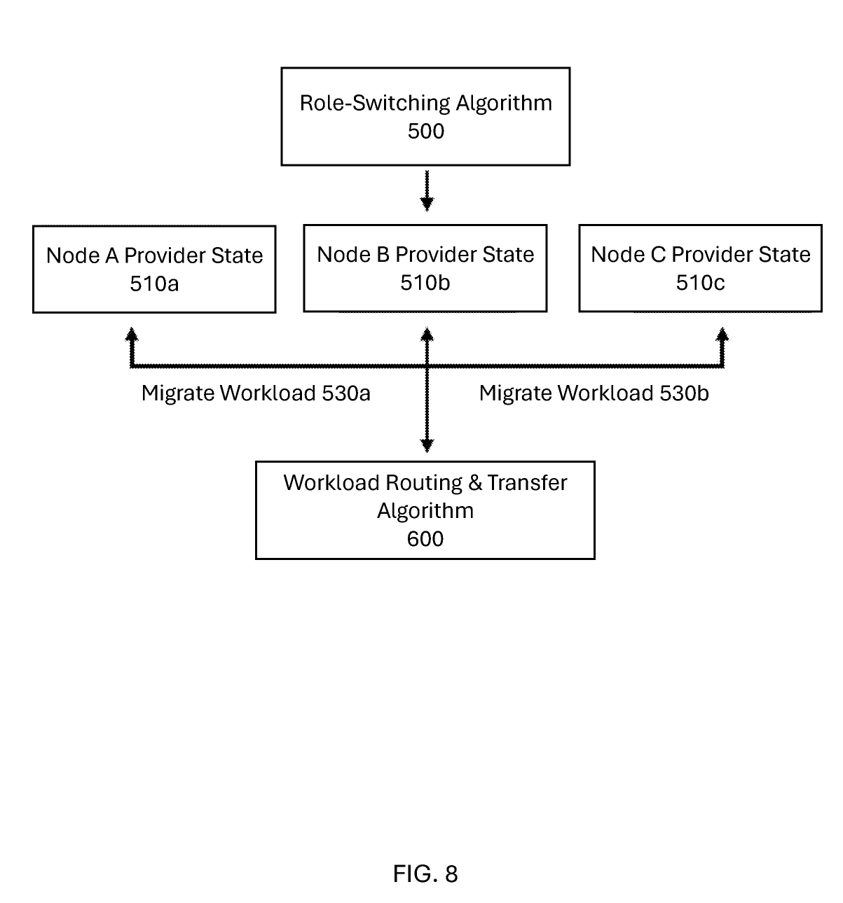

The workload and energy orchestration core 100 also includes a role-switching algorithm 500, which dynamically transitions processor nodes between an active state in which the processor node is executing the one or more compute tasks for the distributed compute mesh, an offloading state in which the processor node is offloading the one or more compute workloads, and an inactive state in which the processor node is withdrawn from the distributed compute mesh. Each processor node may maintain one or more flexibility or priority metrics that may be functions of energy elasticity, compute elasticity, thermal and performance margins, network latency and bandwidth headroom, predicted renewable availability, carbon intensity, and expected revenue potential. The role-switching algorithm 500 may autonomously suspend exposure of each processor node to the one or more compute workloads responsive to a local reliability condition, an energy scarcity event, or a grid flexibility signal, and suspended workloads may be resumed when local or system-wide energy conditions improve. The role-switching algorithm 500 is discussed in greater detail below in reference to FIGS. 7-8.

The workload and energy orchestration core 100 further includes a workload routing and transfer algorithm 600, which ensures that the one or more compute workloads are securely and accurately routed to one or more of the processing resources 104a, 104b, and 104c based on the determination by the prioritization algorithm 400. The workload routing and transfer algorithm 600 may route the one or more compute workloads to one or more processor nodes having a highest predicted profitability or highest predicted operational suitability. In some aspects, larger computational tasks may be divided into smaller, discrete units that can be processed independently across multiple nodes in parallel. In this case, the workload routing and transfer algorithm 600 ensures that workloads are dynamically migrated specific processor nodes. Accordingly, the workload routing and transfer algorithm 600 ensures that the orchestrator translates prioritization outcomes into concrete execution placement within the distributed mesh. The workload routing and transfer algorithm 600 is discussed in greater detail below in reference to FIGS. 2-4 and 7-8.

The core 100 also includes a local execution and resource manager 700, which handles runtime operations and monitors node participation conditions at each processor node. The local execution and resource manager 700 may monitor thermal behavior and local application constraints at each processor node and inform the role-switching algorithm 500 if state changes become necessary. The local execution and resource manager 700 enables each processor node to provide a secure, sandboxed environment for executing computational tasks to ensure system integrity and data privacy. In some aspects, the local execution and resource manager 700 provided at each processor node may be adapted to facilitate storage of one or more compute workloads in a queue for later execution during periods of limited communication connectivity or capacity. Additionally, the local execution and resource manager 700 of the processor node may be adapted to provide processed compute workloads from the node to the core 100 (e.g., via the local controller component proximate the node) to be verified by the core and sent back to the compute client for compensation. The local execution and resource manager 700 is discussed in greater detail below in reference to FIG. 3.

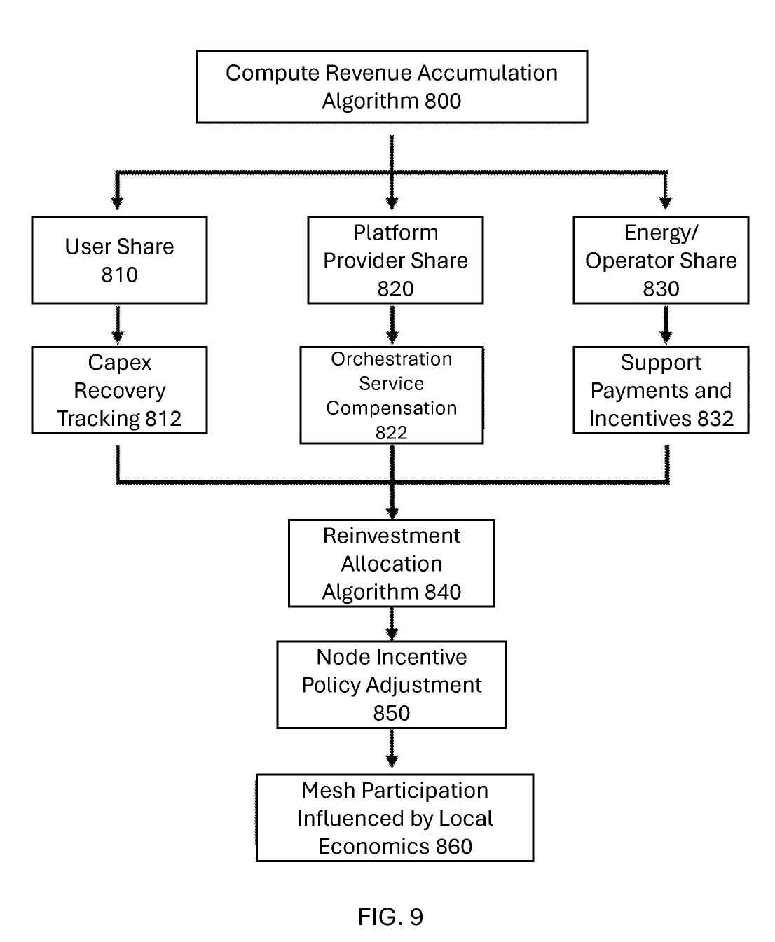

As further shown in FIG. 1A, the workload and energy orchestration core 100 includes a compute revenue accumulation algorithm 800, responsible for aggregating payments from compute workload processing and distributing compute-related compensation to owners of the processing resources 104a, 104b, and 104c and operational partners based on the processed compute workloads. Compensation may be based on latency and throughput characteristics, availability and uptime, quality metrics and result validation, and energy-related metrics including carbon performance. The compute revenue accumulation algorithm 800 may allocate residual or recurring earnings through a reinvestment allocation engine which supports device upgrades, additional node enrollments, and reinvestment into mesh expansion. A node incentive policy adjustment mechanism may update participation priorities to increase the mesh share of devices contributing strong economic performance based on economic outcomes observed through a mesh participation influenced by local economics module. The compute revenue accumulation algorithm 800 is discussed in greater detail below in reference to FIGS. 3 and 9.

With continued reference to FIG. 1A, the workload and energy orchestration core 100 can also include external market interfaces 900, which enables customers, cloud platforms, and AI workloads to interact with the system 1000 as if it were a single, highly scalable data center. In some aspects, the task data may be received from the compute client via the external market interfaces 900. The system 1000 may support compute tasks that range from AI inference, training segments, rendering, simulation, validation, or general-purpose GPU/CPU workloads. The external market interfaces 900 may also be the link that allows for the system to execute computation on behalf of cloud platforms or enterprise workloads during periods of low-cost or on-site renewable power. For example, the external market interfaces 900 can provide an interface for each processor node, or an aggregated compute pool, or the entire distributed mesh to advertise information to potential compute clients. In some aspects, relevant advertising information can include processor capabilities (e.g., type, performance, supported instruction sets), available runtime or duty cycle constraints, energy interface characteristics (e.g., grid-tied, solar-backed, battery-backed, EV-charging), current participation readiness and expected availability windows, etc.

Bidirectional arrows between adjacent components in FIG. 1A indicate data flow and coordination throughout the workload and energy orchestration core 100, enabling continuous optimization of workload placement and economic returns based on real-time energy and market conditions. The workload and energy orchestration core 100 may verify the processed compute workloads for accuracy and integrity using methods such as checksums, redundancy, or cross-validation. The workload and energy orchestration core 100 may provide training data to the plurality of edge computing algorithms, wherein the training data characterizes at least one of observed execution performance, realized profitability, and realized operational suitability associated with the processed compute workloads. A policy learning module may compare predicted workload performance versus actual completion times, predicted revenue versus realized profit or margin, and predicted energy consumption versus measured usage and cost. Learning may be centralized, distributed, or hybrid, with local models updated incrementally to reduce the need for frequent global retraining.

The mesh network of the system 1000 may coexist with centralized orchestration core 100, allowing both peer-to-peer and hub-oriented communication patterns as needed. The system 1000 may utilize Reinforcement Learning Models, Graph Neural Networks, Time-Series Forecasting Models, or Optimization Algorithms with AI Enhancements to manage energy loads, predict grid demands, and optimize DERs.

FIG. 2 is a flow diagram illustrating an exemplary grid-responsive participation workflow performed by the core 100, and more specifically, by the participation decision algorithm 200. As shown in FIG. 2, the core 100 can be arranged to receive inputs from a grid signal intake gateway 116 and a market signal intake gateway 117. The grid signal intake gateway 116 provides signals characterizing local grid conditions including voltage levels, frequency measurements, congestion indicators, and reliability event notifications. The market signal intake gateway 117 receives compute market signals characterizing local compute market pricing, workload demand, and economic incentives available for compute execution. In some aspects, the core 100 can be arranged to receive inputs from a grid signal intake gateway 116 and a market signal intake gateway 117 at the edge devices, e.g., the routers 105a-105c and/or the processor nodes themselves. The grid signal intake gateway 116 and the market signal intake gateway 117 provide two complementary input streams that feed into the workload and energy orchestration core 100, which performs global grid and compute coordination functions.

Using the signals received from the gateways 116, 117, and the data from the task 101, the participation decision algorithm 200 of the core can evaluate the signals in view of the task to determine whether each processor node in the mesh 102 should contribute to compute execution or support the grid through flexibility services. For example, in some aspects, the participation decision algorithm 200 may determine whether the one or more compute workloads should be executed using one or more of the plurality of processor nodes based on at least one of task data, energy data, compute data, a capacity of the processing resources 104a, 104b, and 104c, and performance metrics of the processing resources 104a, 104b, and 104c. The participation decision algorithm 200 can feed into the workload routing and transfer algorithm 600, which handles the distribution of executable tasks to specific processor nodes within the distributed compute mesh. For example, as shown in FIG. 2, the processor nodes can be a plurality of heterogeneous processor types arranged in parallel, which can include, but are not limited to: a CPU 140a, a GPU 140b, an NPU 140c, an EV processor 140d, and a quantum accelerator 140e. The CPU 140a, the GPU 140b, the NPU 140c, the EV processor 140d, and the quantum accelerator 140e may form part of the processing resources 104a, 104b, and 104c within the flexible VDC 102. In some aspects, the processing resources may further include ASICs and FPGAs as programmable compute devices, consumer electronics such as smartphones, laptops, smart appliances, and gaming consoles, as well as industrial controllers and gateway devices. In some aspects, the processing resources may also include fog computing nodes deployed in industries requiring real-time data processing and low-latency responses, such as smart transportation systems where fog nodes installed on roadside units process data from connected vehicles and sensors locally, manufacturing plants where fog nodes analyze sensor data on-site to detect anomalies and predict equipment failures, and healthcare applications where fog computing enables instant patient monitoring and alerting.

As shown in FIG. 2, each of the heterogeneous processor nodes 140a-140d can be equipped with a local grid-responsive management module 210a-210e, which can be a software module provided on each processor node 140a-140d. The local grid-responsive management modules 210a, 210b, 210c, 210d, and 210e, in harmony with the participation decision algorithm 200, are adapted to autonomously modulate participation of each node 140a-140d in executing the compute workloads based on processor conditions and changing energy availability and grid conditions such as voltage fluctuations, frequency events, or local grid congestion. For example, each local grid-responsive management module 210a, 210b, 210c, 210d, and 210e may autonomously adjust workload execution in response to voltage deviations, local congestion, cost-of-energy signals, and carbon intensity indicators.

In some aspects, the local grid-responsive management modules 210a, 210b, 210c, 210d, and 210e may function as local controller components of the workload and energy orchestration core 100, and work with the participation decision algorithm 200 to autonomously decide whether it would be economically or computationally viable for the mesh 102 to participate in executing the task 101. The local grid-responsive management modules 210a-210e and the participation decision algorithm 200 decide whether the mesh 102 will participate based on voltage deviations, local congestion, cost-of-energy, carbon intensity indicators, etc. Local renewable power availability, for example, may be a factor that increases profitability of executing the tasks 101, and may result in the participation decision algorithm 200 deciding to participate. Alternatively, when grid stress emerges, the participation decision algorithm 200 may decide not to participate and instead participate in grid flexibility services. For example, each node 140a-140d may integrate with DERs (e.g., rooftop photovoltaic generation, stationary batteries, heat pump systems, smart appliances, etc.), and the core 100 may decide to participate in grid flexibility services by trading surplus energy with the grid 108 or other nodes, facilitated by smart contracts or energy marketplaces. Accordingly, in some aspects, the distributed compute mesh may operate as a virtual power plant (VPP) by aggregating the flexible compute loads across the processor nodes 140a-140e and coordinating their participation in grid services as a unified dispatchable resource.

For example, the local grid-responsive management module 210a may manage participation by the EV processor 140d based on State of Charge (SOC), charging schedule and expected departure time, local energy prices, and local grid reliability signals received through the local grid-responsive management module 210d. When the EV SOC is high and energy costs are low, the local grid-responsive management module 210a may indicate that participation is desirable, and with elevated price or frequency instability, participation may be reduced. Similarly, the local grid-responsive management module 210e may decide that it would be desirable for the quantum accelerator 140e to participate if it is available, and energy/compute costs are favorable, and the workload would benefit from quantum processing.

As further shown in FIG. 2, decisions made by the local grid-responsive management modules 210a-210e and the participation decision algorithm 200 and compensation from completed tasks are then tracked in the Grid Services Participation and Incentives Module 220 to train the algorithm 200 and improve participation decision making. Accordingly, grid services participation may generate value through direct incentives, avoided energy costs, capacity relief, reliability support, or other economic or operational benefits associated with flexible load behavior.

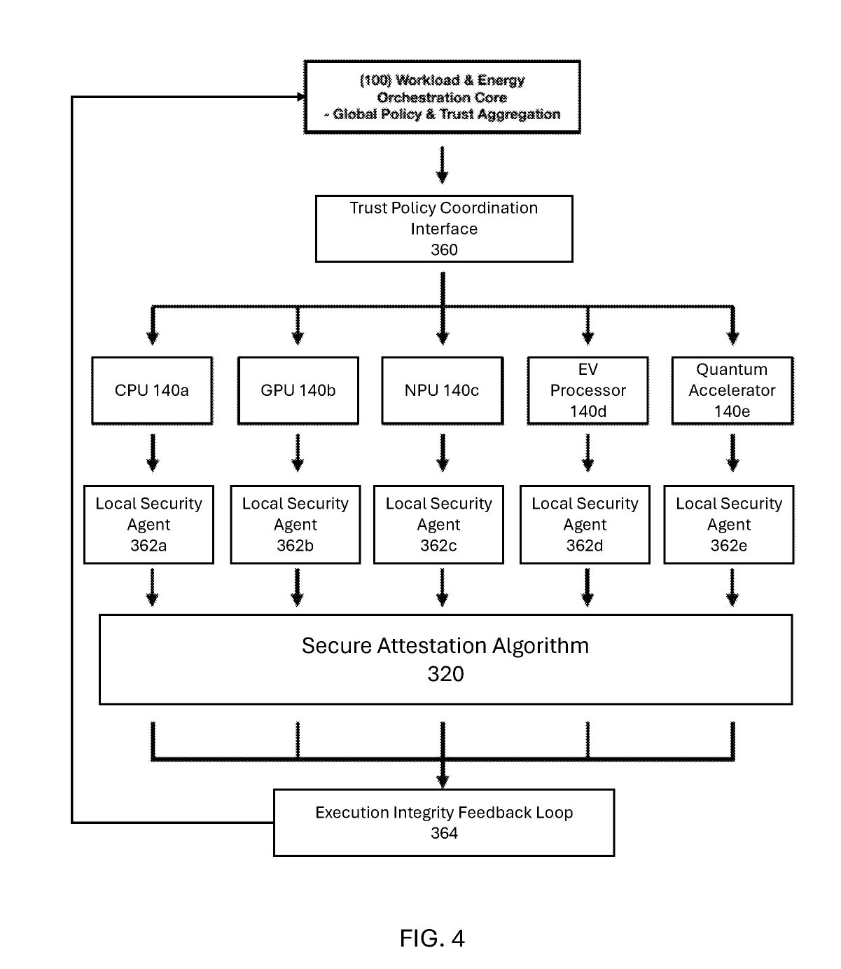

FIGS. 3 and 4 are diagrams illustrating exemplary node enrollment and trust-based security functionalities described herein, which enable secure onboarding and verification of processor nodes within the distributed compute mesh. Specifically, the enrollment algorithm 300 will be described below in reference to FIG. 3, which handles the secure registration of heterogeneous processor nodes into the mesh. The trust policy coordination interface 360, which manages trust evaluations and policy enforcement across the distributed compute mesh, will be described below in reference to FIG. 4.

Referring to FIG. 3, a flow diagram illustrating an exemplary enrollment process for processor nodes within the distributed compute mesh is shown. The enrollment algorithm 300 initiates the enrollment of heterogeneous processor nodes into the system 1000 via the workload and energy orchestration core 100. The enrollment algorithm 300 receives enrollment requests from a plurality of processor types including the CPU 140a, the GPU 140b, the NPU 140c, the EV processor 140d, and the quantum accelerator 140e. Each processor type includes a corresponding device identity 310a-310e, with 310a providing the identity of the CPU 140a, 310b providing the identity of the GPU 140b, 310c providing the identity of the NPU 140c, 310d providing the identity of the EV processor 140d, and 310e providing the identity of the quantum accelerator 140e. These device identity elements represent verified hardware credentials and configuration metadata for each respective processor.

A secure attestation layer 320 of the enrollment algorithm 300 is configured to receive the device identity elements 310a-310e from the processor nodes 140a-140e, as shown in FIG. 3. The secure attestation layer 320 evaluates, based on the device identities 310a-310e, whether each processor possesses appropriate integrity, onboarding trust level, and compliance with security requirements for participation in the mesh. Following validation by the secure attestation layer 320, an access permissions assignment layer 330 of the enrollment algorithm 300 applies contextual rules to define the types of compute tasks each processor may handle, any operational restrictions, and whether participation may be conditioned on energy availability or economic thresholds. After permissions are assigned, mesh participation rules 340 of the enrollment algorithm 300 bind each device to an allowed operational mode such as provider, consumer, or standby state, subject to dynamic role-switching events triggered at runtime, as described in greater detail below.

As further shown in FIG. 3, the enrollment process performed by the enrollment algorithm 300 can establish communication with the distributed mesh 102 at a step 350. The connection to distributed mesh 350 enables the enrolled processor nodes to receive workloads from the workload routing and transfer algorithm 600 and to communicate with other nodes within the flexible VDC 102, as discussed in greater detail below. In some aspects, the enrollment algorithm 300 can rely on communication protocols that include standard technologies such as TCP/IP, HTTP, MQTT, and gRPC, with all control and data traffic protected by encryption and authentication mechanisms. The distributed compute mesh may coexist with centralized orchestration, allowing both peer-to-peer and hub-oriented communication patterns as needed. In some aspects, enrollment may use secure identity certificates or keys, trusted execution and hardware attestation mechanisms, optional hardware roots-of-trust, and optional reputation or scoring models. The layered sequence shown in FIG. 3 enables devices to join or leave the distributed compute mesh intermittently while maintaining secure, resilient, and flexible distributed compute services within the system 1000.

Referring to FIG. 4, a diagram illustrating an exemplary distributed trust and attestation system for the distributed compute mesh is shown. The trust policy coordination interface 360 of the core 100 is communicatively coupled to a plurality of heterogeneous processor nodes including the CPU 140a, the GPU 140b, the NPU 140c, the EV processor 140d, and the quantum accelerator 140e. Additionally, each of these processor nodes 140a-140e can be configured to host a corresponding local security agent 362a-362e that acts as a cryptographic enforcement point for policies issued by the trust policy coordination interface 360. In some aspects, the local security agents 362a-362e can receive trust policies from the trust policy coordination interface 360 and enforce the trust policies at each respective processor node 140a-140e, and can communicate with the secure attestation layer 320. The secure attestation layer 320 validates the integrity of both device identity and runtime behavior before workloads are executed on the respective processor nodes. The local security agents 362a-362e can also be adapted to exchange attestation evidence between nodes to ensure that no single trust anchor can compromise system integrity. This configuration allows for each processor node 140a-140e to provide a secure, sandboxed environment for executing computational tasks, ensuring system integrity and data privacy.

As further shown in FIG. 4, execution integrity results from each processor node are aggregated into an execution integrity feedback loop 364, which provides feedback to the workload and energy orchestration core 100. The execution integrity feedback loop 364 enables the workload and energy orchestration core 100 to adjust node participation, suspend compromised nodes, and reward stable nodes with more profitable workloads. The architecture distributes integrity enforcement across the processor nodes while maintaining globally optimized orchestration-level trust decisions through the workload and energy orchestration core 100.

In some aspects, the core 100 (either at the cloud level, or at the local controller level) may restrict or enhance future workload assignment to the processor nodes 140a-140e based on determined security levels of the nodes. For example, the core 100 and/or each local controller component may be configured to receive attestation results from the execution integrity feedback loop 364 and may generate trust evaluations for the processor nodes based on the attestation results received. The core 100 and/or each local controller component may restrict or enhance future workload assignment to the processor node based on the trust evaluations. The trust policy coordination interface 360 may coordinate with the secure attestation layer 320 to manage trust evaluations and policy enforcement across the distributed compute mesh, enabling the workload and energy orchestration core 100 to adjust node participation, suspend compromised nodes, and reward stable nodes with more profitable workloads.

In some aspects, the enrollment and trust-based security functionalities provided by the enrollment algorithm 300 and trust policy coordination interface 360 can also support distributed ledger or consensus mechanisms, which may optionally be used to record transactions, validate participation, or support auditability of compute and energy exchanges within the distributed compute mesh. Trust may also be provided through optional decentralized reputation or scoring systems maintained by the workload and energy orchestration core 100 or a distributed system.

The prioritization algorithm 400, the role-switching algorithm 500, the workload routing and transfer algorithm 600, and the local execution and resource manager 700 (including local execution and resource managers 700a, 700b, 700c, 700d, and 700e), will now be described below with references made variously to FIGS. 5-8. Specifically, FIG. 5 is a flow diagram illustrating an exemplary task execution workflow performed by various components of the core 100. FIG. 6 is a flow diagram illustrating an exemplary workload classification, prioritization, and routing process performed by the prioritization algorithm 400 and workload routing and transfer algorithm 600, respectively. FIG. 7 is a flow diagram illustrating an exemplary workload prioritization and decision process performed by the prioritization algorithm 400, with role-switching and routing/transferring performed by the role-switching algorithm 500 and the workload routing and transfer algorithm 600, respectively. FIG. 8 illustrates an exemplary role-switching and workload migration functionality performed by the role-switching algorithm 500 and the workload routing and transfer algorithm 600, respectively.

FIG. 5 depicts the sequential progression from signal intake through participation decision-making, prioritization, workload distribution, local execution management, and revenue accumulation within the distributed compute mesh architecture. Similarly to as described above in reference to FIG. 2, the core 100 can be arranged to receive signals from the external grid signal intake gateway 116 and the market signal intake gateway 117. Based on the signals received by the grid signal intake gateway 116 and the market signal intake gateway 117, the real-time signal intake 110 can parse out a variety of signals, as discussed in greater detail below in reference to FIGS. 6 and 7.

The participation decision algorithm 200 and the prioritization algorithm 400 determine whether compute workloads should be executed using available processor nodes within the distributed compute mesh. The participation decision algorithm 200 has been discussed in detail above, accordingly it will not be discussed further below. Once it is determined, by the participation decision algorithm 200, that the mesh 102 is going to participate in executing the task 101, the prioritization algorithm 400 then evaluates the incoming signals to determine whether the one or more compute workloads should execute locally on a specific processor node, be migrated to another processor node, be deferred for later executing at that processor node, or be rejected by that processor node, depending on predicted profitability and operational suitability. Specifically, the prioritization algorithm 400 is responsible for evaluating predicted profitability and operational suitability for executing workloads at the respective edge devices (e.g., processing resources 140a-140e) based on the received signal data. The prioritization algorithm 400 determines a predicted profitability and predicted operational suitability associated with executing the one or more compute workloads based on the task data, the energy data, and the compute data, and the specific processor conditions. Accordingly, the prioritization algorithm 400 differs from the participation decision algorithm 200 in that the participation decision algorithm 200 determines whether a node should participate in compute execution based on energy availability, grid conditions, and reliability constraints, while the prioritization algorithm 400 operates on workloads that have been accepted into the mesh 102 for execution; to rank, route, migrate, or defer those workloads among participating nodes.

For example, in reference to FIG. 6, in some aspects, the real-time signal intake 110 can include energy availability 111, energy cost 112, market pricing 113, SLA/deadline inputs 114, and workload criteria 115. The energy availability 111 characterizes local energy availability proximate the processing resources 104a, 104b, and 104c. The energy cost 112 characterizes energy pricing proximate the processing resources 104a, 104b, and 104c. The market pricing 113 characterizes compute market pricing proximate the processing resources 104a, 104b, and 104c. The SLA/deadline inputs 114 characterize service level agreements for the one or more compute workloads received from the compute client. The workload criteria 115 provides the data for subsequent classification and routing decisions. For example, as shown in FIG. 6, in some aspects, the workload criteria 115 can include metadata that classifies a specific task as either a time-critical workload 115a or an opportunistic workload 115b. The time-critical workloads 115a represent compute tasks with strict latency constraints or high service-level commitment value. The opportunistic workloads 115b represent compute tasks that tolerate deferred execution and are generally more cost-sensitive. With continued reference to FIG. 6, both the time-critical workloads 115a and the opportunistic workloads 115b are received by the prioritization algorithm 400, which evaluates the classified workloads against the energy availability 111, the energy cost 112, the market pricing 113, and the SLA/deadline inputs 114 received through the real-time signal intake 110 to determine execution timing and placement decisions. The prioritization algorithm 400 may be configured to determine whether the one or more compute workloads should be executed immediately using one or more of the processing resources 104a, 104b, and 104c (e.g., if energy economics are favorable), or if the one or more compute workloads should be deferred or batch-processed (e.g., if conditions are temporarily unfavorable). From the prioritization algorithm 400 associated with each workload class, the selected actions are forwarded to the workload routing and transfer algorithm 600, which performs the actual movement of executable tasks to a specific processor nodes, ensuring that the orchestrator translates prioritization outcomes into concrete execution placement within the distributed mesh, as discussed in greater detail below. Through this classification and routing structure, the orchestrator optimally aligns compute demand with energy conditions while maintaining SLA compliance and maximizing revenue capture.

In making the priority determinations, each processor node may advertise information including processor capabilities, available runtime or duty cycle constraints, energy interface characteristics, current participation readiness, and expected availability windows. The core 100 may profile each device's available processing resources, current workload, and energy status for task assignment decisions. For example, each device may maintain one or more flexibility or priority metrics that may be functions of energy elasticity, compute elasticity, thermal and performance margins, network latency and bandwidth headroom, predicted renewable availability, carbon intensity, and expected revenue potential. Based on the evaluation performed by the prioritization algorithm 400, the process branches into four possible outcomes, which will now be described in greater detail below in reference to FIG. 7.

As shown in FIG. 7, after receiving the real-time inputs 110, the prioritization algorithm 400 can weigh the considerations discussed above, for each processor node, to determine whether that specific node should: execute the workload 401, migrate the workload 402, reject the workload 403, or defer the workload 404. For example, each local controller component may be configured to determine, by the prioritization algorithm 400, the predicted profitability and predicted operational suitability associated with executing the one or more compute workloads by a processor node proximate the local controller component based on the task data, the energy data, and the compute data and the processor conditions. In some aspects, each local controller component may generate a set of priority rules for routing the one or more compute workloads, where the set of priority rules are generated based on the task data, the energy data, the compute data, performance of the processor node, and the predicted profitability and predicted operational suitability. In some aspects, the workload bids or assignments (e.g., tasks) may be evaluated based on expected profitability and risk, resilience impact and redundancy needs, and contribution to overall mesh flexibility and grid-support capability. In some aspects, tasks with a positive expected margin, calculated as compute revenue minus energy cost and device wear, may be prioritized.

If the prioritization algorithm 400 determines, for a specific processor node, that the task should be executed by that processor node, at 401, based on the considerations described above, then the workload is dispatched for local execution when local execution is profitable and operationally favorable, relying on the local execution and resource manager 700 (including local execution and resource managers 700a, 700b, 700c, 700d, and 700e), as will be described in greater detail below.

If the prioritization algorithm 400 determines, for a specific processor node, that the task should be migrated to another processor node, at 402, based on the considerations described above, then the workload is transferred to a different processor node that provides better energy or revenue conditions at that time, relying on the role-switching algorithm 500 and the workload routing and transfer algorithm 600, as will be described in greater detail below. For example, each local controller component may migrate the one or more compute workloads, by the prioritization algorithm 400, to another processor node responsive to determining that the other processor node exhibits a higher predicted profitability or has sufficient capacity.

If the prioritization algorithm 400 determines, for a specific processor node, that the task should be rejected, at 403, based on the considerations described above, then the workload is declined when execution would yield negative earnings or impair operational reliability, relying on the role-switching algorithm 500, as will be described in greater detail below. For example, each local controller component may reject the one or more compute workloads responsive to the determining, by the prioritization algorithm 400, that the predicted profitability is negative or that the processor node proximate the local controller component does not have sufficient capacity.

If the prioritization algorithm 400 determines, for a specific processor node, that the task should be deferred, at 404, based on the considerations described above, then the workload is postponed for later execution when current conditions are temporarily unfavorable, relying on the queuing functionalities described variously herein.

Each local controller component may update the set of priority rules dynamically based on observed execution performance by the processor node, a realized profitability, and a realized operational suitability. Specifically, as further shown in FIG. 7, after the workloads are routed by the workload routing and transfer algorithm 600 and executed, the prioritization algorithm 400 can further include a policy learning module 410 that is adapted to receive feedback including performance feedback, profitability feedback, and reliability responses. After each workload decision is made, the policy learning module 410 analyzes observed outcomes including realized profitability, task completion time, and energy condition responses relative to predictions made by the prioritization algorithm 400. The policy learning module 410 compares predicted workload performance versus actual completion times, predicted revenue versus realized profit or margin, and predicted energy consumption versus measured usage and cost. The policy learning module 410 then updates dispatch preferences and future workload participation rules within the workload and energy orchestration core 100. The policy learning module 410 provides feedback to the workload and energy orchestration core 100, creating a closed adaptive feedback loop that enables continuous improvement of decision-making capabilities based on accumulated performance data. In some aspects, this learning may be centralized, distributed, or hybrid, with local models updated incrementally to reduce the need for frequent global retraining. In some aspects, the core 100 may utilize Reinforcement Learning Models, Graph Neural Networks, Time-Series Forecasting Models, or Optimization Algorithms with AI Enhancements to improve the prioritization algorithm 400.

With continued reference to FIG. 7, the role-switching algorithm 500 receives operational information and updates each processor node's current mode based on the determination made by the prioritization algorithm 400. As described above, the prioritization algorithm 400 determines whether each processor node should execute the workload at 401, migrate the workload at 402, reject the workload at 403, or defer the workload at 404. The role-switching algorithm 500 receives these determination outcomes and transitions each processor node between operational states accordingly, as discussed below in reference to FIG. 8.

Referring to FIG. 8, the role-switching algorithm 500 manages transitions between three operational states for processor nodes within the distributed compute mesh. For example, when the prioritization algorithm 400 determines that a processor node should execute the workload at 401, the role-switching algorithm 500 may transition that processor node to an active state, or a node A provider state 510a. The node A provider state 510a represents a processor node that is actively executing compute tasks and offering compute resources to the distributed compute mesh. In the node A provider state 510a, the processor node is able to receives workloads from the workload routing and transfer algorithm 600 and processes the workloads using the local execution and resource manager 700.

When the prioritization algorithm 400 determines that a processor node should migrate the workload at 402, the role-switching algorithm 500 may transition that processor node to an offloading state, or a node B provider state 510b. The node B provider state 510b represents a processor node that is offloading compute tasks to other nodes because local conditions render local execution unsuitable. In the node B provider state 510b, the processor node may transfer workloads to other processor nodes that exhibit more favorable energy or revenue conditions.

When the prioritization algorithm 400 determines that a processor node should reject the workload at 403 or defer the workload at 404, the role-switching algorithm 500 may transition that processor node to an inactive state or maintain the processor node in a standby configuration, or a node C provider state 510c. The node C provider state 510c represents a processor node that temporarily withdraws compute exposure entirely, prioritizing local loads or idle conservation. In the node C provider state 510c, the processor node may suspend participation in the distributed compute mesh responsive to a local reliability condition, an energy scarcity event, or a grid flexibility signal.

The role-switching algorithm 500 may transition processor nodes between these operational states based on energy availability, energy cost, workload urgency, projected profitability, thermal conditions, and network state. For example, the role-switching algorithm 500 may transition a processor node from the node A provider state 510a to the node B provider state 510b when local energy costs increase or when another processor node exhibits higher predicted profitability. The role-switching algorithm 500 may transition a processor node from the node A provider state 510a or the node B provider state 510b to the node C provider state 510c when grid stress emerges or when local reliability conditions require reserving power for functions other than compute execution.

With continued reference to FIG. 8, the workload routing and transfer algorithm 600 facilitates the movement of compute workloads between processor nodes based on the operational state transitions managed by the role-switching algorithm 500, which is illustrated in FIG. 8 by the migrate workload signals 530a, 530b.

The role-switching algorithm 500 may autonomously suspend exposure of each processor node to the one or more compute workloads responsive to a local reliability condition, an energy scarcity event, or a grid flexibility signal. Suspended workloads may be resumed when local or system-wide energy conditions improve. For example, when a processor node transitions from the node C provider state 510c back to the node A provider state 510a, the workload routing and transfer algorithm 600 may route queued workloads to that processor node for execution. The process continues from the role-switching algorithm 500 to the workload routing and transfer algorithm 600, which performs the actual movement of executable tasks to specific processor nodes within the distributed compute mesh based on the operational state transitions and migration signals described above.

As briefly mentioned above in reference to FIG. 2, the workload routing and transfer algorithm 600 handles the distribution of executable tasks to specific processor nodes within the distributed compute mesh. Referring again to FIG. 5, the workload routing and transfer algorithm 600 receives prioritization outcomes from the prioritization algorithm 400 and routes the one or more compute workloads to processor nodes having a highest predicted profitability or highest predicted operational suitability. The workload routing and transfer algorithm 600 translates the prioritization outcomes into concrete execution placement within the distributed compute mesh by directing workloads to the heterogeneous processor types including the CPU 140a, the GPU 140b, the NPU 140c, the EV processor 140d, and the quantum accelerator 140e.

In some aspects, the workload routing and transfer algorithm 600 may divide larger computational tasks into smaller, discrete units that can be processed independently across multiple processor nodes in parallel. The workload routing and transfer algorithm 600 may segment large computational tasks based on workload type, data requirements, and energy conditions at each processor node. The workload routing and transfer algorithm 600 may assign the segmented task units to processor nodes predicted to provide favorable performance and energy economics. As shown in FIG. 5, the workload routing and transfer algorithm 600 distributes the segmented task units to the CPU 140a, the GPU 140b, the NPU 140c, the EV processor 140d, and the quantum accelerator 140e based on the capabilities and availability of each processor node.

Additionally, with reference to FIG. 6, the workload routing and transfer algorithm 600 receives selected actions from the prioritization algorithm 400 following workload classification and prioritization. As discussed above, the prioritization algorithm 400 evaluates the time-critical workloads 115a and the opportunistic workloads 115b against the energy availability 111, the energy cost 112, the market pricing 113, and the SLA/deadline inputs 114 to determine execution timing and placement decisions. The workload routing and transfer algorithm 600 receives these prioritization outcomes and performs the actual movement of executable tasks to specific processor nodes within the distributed compute mesh. For the time-critical workloads 115a, the workload routing and transfer algorithm 600 may prioritize routing to processor nodes with low latency and high availability. For the opportunistic workloads 115b, the workload routing and transfer algorithm 600 may route workloads to processor nodes with favorable energy economics, even if execution is deferred.

Moreover, in reference to FIG. 7, the workload routing and transfer algorithm 600 receives routing instructions based on the four possible outcomes determined by the prioritization algorithm 400. When the prioritization algorithm 400 determines that a workload should be executed, at 401, the workload routing and transfer algorithm 600 routes the workload to the designated processor node for local execution. When the prioritization algorithm 400 determines that a workload should be migrated, at 402, the workload routing and transfer algorithm 600 transfers the workload to a different processor node that provides better energy or revenue conditions. When the prioritization algorithm 400 determines that a workload should be rejected or deferred, at 403, the workload routing and transfer algorithm 600 may redirect the workload to alternative processor nodes or queue the workload for later execution, or may communicate such a decision to the core 100 to inform the participation decision algorithm 200. If a sufficient number of nodes reject a workload, the participation decision algorithm 200 may ultimately decide that the mesh 102 should not participate in the execution of the task. In such a case, the task may be diverted to a physical data center 103a, 103b or some other external compute system for conventional execution.

Referring to FIG. 8, the workload routing and transfer algorithm 600 facilitates workload migration between processor nodes following role-switching operations managed by the role-switching algorithm 500. The migrate workload signal 530a and the migrate workload signal 530b enable the workload routing and transfer algorithm 600 to transfer workloads between processor nodes when the role-switching algorithm 500 transitions processor nodes between the node A provider state 510a, the node B provider state 510b, and the node C provider state 510c. For example, when a processor node transitions from the node A provider state 510a to the node B provider state 510b, the workload routing and transfer algorithm 600 may receive the migrate workload signal 530a and transfer pending workloads from that processor node to another processor node that remains in an active execution state. In some aspects, communication between nodes can occur directly or via intermediate relays, can scale as devices join and leave without redesigning the network, and provide redundancy and resilience against individual device or link failures. The role-switching algorithm 500 and workload routing and transfer algorithm 600 may detect and mitigate faults, redistributing tasks as needed to maintain operational continuity. In some aspects, fault tolerance for intermittent connectivity may include buffering and eventual consistency mechanisms.

Following routing by the workload routing and transfer algorithm 600, the process continues to the local execution and resource manager 700, which handles runtime operations and monitors node participation conditions at each processor node within the distributed compute. As shown in FIG. 5, the local execution and resource manager 700 includes node-specific instances comprising the local execution and resource manager 700a associated with the CPU 140a, the local execution and resource manager 700b associated with the GPU 140b, the local execution and resource manager 700c associated with the NPU 140c, the local execution and resource manager 700d associated with the EV processor 140d, and the local execution and resource manager 700e associated with the quantum accelerator 140e. Each local execution and resource manager 700a, 700b, 700c, 700d, and 700e receives workloads from the workload routing and transfer algorithm 600 and manages task execution at the respective processor node.

The local execution and resource manager 700 and the node-specific instances 700a-700e differ in function from the local grid-responsive management modules 210a-210e described above in reference to FIG. 2. Specifically, the local execution and resource manager 700 and the node-specific instances 700a-700e control how a workload runs on a processor node, including execution scheduling, performance optimization, thermal limit enforcement, and runtime control. In contrast, the local grid-responsive management modules 210a-210e control whether the processor node should participate in compute execution at all based on energy availability and grid conditions, and may suspend, throttle, or exit compute participation during grid events, as discussed above.

The local execution and resource manager 700 monitors thermal behavior and local application constraints at each processor node. When the local execution and resource manager 700 detects that thermal conditions exceed acceptable thresholds or that local application constraints require adjustment, the local execution and resource manager 700 informs the role-switching algorithm 500 if state changes become necessary. For example, if the local execution and resource manager 700a associated with the CPU 140a detects elevated thermal conditions, the local execution and resource manager 700a may signal the role-switching algorithm 500 to transition the CPU 140a from an active execution state to a standby or offloading state.

Each processor node may provide a secure, sandboxed environment for executing computational tasks to ensure system integrity and data privacy. The local execution and resource manager 700 and the node-specific instances 700a-700e enable each processor node to isolate workload execution from other processes running on the processor node, protecting local data and system resources from interference by distributed compute tasks. Each processor node may maintain one or more flexibility or priority metrics that may be functions of energy elasticity, compute elasticity, thermal and performance margins, network latency and bandwidth headroom, predicted renewable availability, carbon intensity, and expected revenue potential. Such flexibility metrics can be implemented using scalar scores, multi-dimensional vectors, or learned models, and are not limited to any specific formula or naming convention.

In some aspects, the local execution and resource manager 700 and the node-specific instances 700a-700e may facilitate storage of one or more compute workloads in a queue for later execution during periods of limited communication connectivity or capacity. For example, if communication between a processor node and the workload and energy orchestration core 100 is temporarily interrupted, the local execution and resource manager 700 may store pending workloads in a local queue and execute the queued workloads when connectivity is restored or when local conditions permit execution. This queuing functionality enables the distributed compute mesh to maintain operational continuity even during communication interruptions.

As shown in FIG. 5, outputs from the local execution and resource manager 700a, the local execution and resource manager 700b, the local execution and resource manager 700c, the local execution and resource manager 700d, and the local execution and resource manager 700e converge and flow to the compute revenue accumulation algorithm 800. The compute revenue accumulation algorithm 800 aggregates payments from compute workload processing across the distributed compute mesh and distributes compensation to device owners and operational partners, as will be described in greater detail below in reference to FIG. 9.

The compute revenue accumulation algorithm 800 is shown and described in detail below in reference to FIG. 9. As distributed compute workloads execute across the distributed compute mesh formed by the flexible VDC 102, revenue from compute market payments is aggregated by the compute revenue accumulation algorithm 800. Accordingly, in some aspects, the compute revenue accumulation algorithm 800 is configured to distribute compute-related compensation to owners of the processing resources provided at each processing node (e.g., processing resources 104a, 104b, and 104c of FIG. 1 and/or processor nodes 140a-140e of FIGS. 2-5 and 10). In some aspects, the compute revenue accumulation algorithm 800 can also be configured to distribute compute-related compensation to operational partners based on the processed compute workloads. Operational partners may include, for example, orchestration platform providers that operate the distributed orchestration infrastructure, grid operators or utilities companies that provide grid support services such as frequency regulation and voltage support, energy retailers or aggregators that participate in demand response programs or transactive energy markets, market operators that coordinate dispatchable virtual power plant capacity, and energy or operator partners that contribute to local grid benefits or renewable integration services. The workload and energy orchestration core 100 coordinates the monetization flow through the compute revenue accumulation algorithm 800, enabling devices to generate revenue by executing compute tasks when doing so is profitable, energy-efficient, or grid-supportive.

Specifically, as shown in FIG. 9, accumulated revenue from the compute revenue accumulation algorithm 800 can be allocated among several parties, including, but not limited to: user shares 810, platform provider shares 820, and energy/operator shares 830. In some aspects, once delivered, the user share 810 can be communicated with a capex recovery tracking module 812, which facilitates cost recovery by tracking progress toward repaying the initial hardware investment over the life of usage. For example, in some aspects, the capex recovery tracking 812 ensures that the initial hardware investment is repaid over the life of usage and generates revenue for the user. A financial or policy state machine may track revenue against initial equipment cost and adjust participation policies to accelerate capital cost recovery where desired.

In some aspects, the platform provider share 820 can further include an associated orchestration service compensation module 822, adapted to compensate the entity that operates the distributed orchestration infrastructure. The orchestration service compensation 822 provides compensation based on the services provided by the workload and energy orchestration core 100 in coordinating workload execution and energy-aware participation across the processing resources (e.g., processing resources 104a, 104b, and 104c of FIG. 1 and/or processor nodes 140a-140e of FIGS. 2-5 and 10).

In some aspects, the energy/operator share 830 is associated with a support payments and incentives module 832, which may reflect payments for local grid benefits or operational partner contributions. The support payments and incentives 832 validates payments when the system 1000 provides ancillary services such as frequency regulation and voltage support to the grid 108. Compensation may be based on latency and throughput characteristics, availability and uptime, quality metrics and result validation, and energy-related metrics including carbon performance.

As further shown in FIG. 9, following the allocation to the user share 810, the platform provider share 820, and the energy/operator share 830, the compute revenue accumulation algorithm 800 can further include a reinvestment allocation engine 840. The reinvestment allocation engine 840 can be adapted to allocate residual or recurring earnings to support device upgrades, additional node enrollments, via the enrollment algorithm 300, and reinvestment into mesh expansion. The compute revenue accumulation algorithm 800 allocates residual or recurring earnings through the reinvestment allocation engine 840, enabling the distributed compute mesh to grow and improve over time.

In some aspects, the compute revenue accumulation algorithm 800 can also include a node incentive policy adjustment 850. The node incentive policy adjustment 850 updates participation priorities to increase the mesh share of devices contributing strong economic performance. The node incentive policy adjustment module 850, which may adjust workload exposure to increase participation from processor nodes that demonstrate favorable economic returns and reliable execution performance. In some aspects, as shown in FIG. 9, the compute revenue accumulation algorithm 800 also include a module 860 that adjusts mesh participation, as influenced by local economics. For example, based on economic outcomes observed through the compute revenue accumulation algorithm 800, the module 860 and the node incentive policy adjustment module 850 can be configured to update participation priorities. Accordingly, revenue distribution and economic feedback directly affect future workload routing and node participation through the mesh participation influenced by local economics 860. This structure enables a financially adaptive and self-optimizing distributed compute ecosystem where economic outcomes observed through the mesh influence subsequent participation decisions.

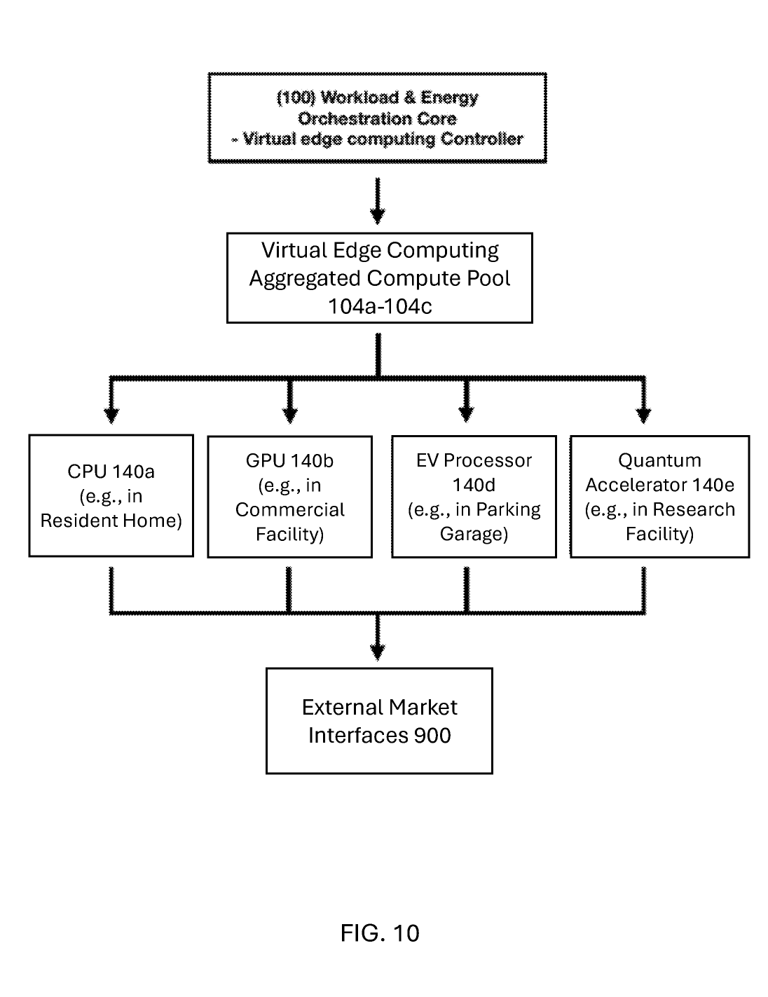

FIG. 10 is a block diagram illustrating one exemplary virtual edge computing architecture showing the relationship between the workload and energy orchestration core 100, an aggregated compute pool, heterogeneous processor nodes, and the external market interfaces 900. The virtual edge computing aggregated compute pool receives coordination signals from the workload and energy orchestration core 100 and manages the distribution of workloads across the heterogeneous processor nodes within the distributed compute mesh. As mentioned above, in some aspects, the plurality of processor nodes of the systems described herein may be located across residential, commercial, industrial, and mobile environments (or deployed across a single facility), and can be aggregated into a unified compute pool, which is accessible to external compute markets. For example, as shown in FIG. 10, the mesh 102 may include a virtual edge computing aggregated compute pool that is comprised of the processing resources 104a-104c. In some aspects, as shown, the processing resources 104a-104c can further include the nodes 140a-140e described above. In the example provided in FIG. 10, the CPU 140a may be provided, for example, in a residential home environment, the GPU 140b may be provided in a commercial building, the EV processor 140d may be provided in a parking garage, and the quantum accelerator 140e may be located in a research or data facility. Accordingly, in some cases, these nodes may be separated by significant geographic distances and operate under differing local energy and connectivity conditions while contributing computational resources to the unified virtual edge computing aggregated compute pool 104a-104c.

As further shown in FIG. 10, the workload and energy orchestration core 100 can be configured to expose the aggregated compute capabilities to global compute markets via the external market interfaces 900, enabling customers, cloud platforms, and AI workloads to interact with the aggregated compute pool 104a-104c as if it were a single, highly scalable data center. The aggregated compute pool 104a-104c allows for the distributed nature of the mesh to dynamically scale compute resources up or down in response to energy pricing, market demand, and node availability. Through this architecture, the aggregated compute pool 104a-104c transforms heterogeneous edge resources into a revenue-producing virtual edge computing cluster, offering the performance advantage of centralized compute while leveraging the cost and energy flexibility of the distributed edge.

Several non-limiting examples of the systems and methods described herein are provided below for illustrative purposes. In some aspects, the systems and methods described herein may comprise a distributed compute mesh including a plurality of heterogeneous processor nodes configured to execute workloads and to autonomously determine participation in workload execution based on at least local energy availability, power cost, processor performance, thermal conditions, network state, and one or more service-level requirements. The heterogeneous processor nodes may comprise at least two of a CPU, a GPU, a neural accelerator, an electric vehicle onboard compute system, an edge server, an IoT compute device, or a quantum accelerator.

In some aspects, each processor node may comprise a secure enrollment mechanism, including identity validation and execution integrity attestation. Attestation results may be transmitted to an orchestration component configured to restrict or enhance future workload assignment based on trust evaluations. Workloads may be routed to processor nodes predicted to provide lowest marginal energy cost or highest operational suitability.

In some aspects, processor nodes may autonomously suspend workload exposure in response to a local reliability condition, an energy scarcity event, or a grid flexibility signal. Suspended workloads may be resumed when local or system-wide energy conditions improve. Workload migration may be triggered when a different processor node exhibits more favorable energy or economic participation conditions.

In some aspects, priority rules for workload placement may be updated based on observed execution performance, energy outcomes, and realized economic contribution. A workload may be rejected when predicted execution yield is negative or would violate a service obligation. A processor node may store queued workloads for later execution during periods of limited communication connectivity.

In some aspects, the system may further comprise a revenue allocation engine configured to distribute compute-related compensation among at least a device owner and a platform operator. Workload exposure may be increased or decreased over time based on progress toward hardware capital expense recovery.

In some aspects, execution behavior of processor nodes may provide adjustable compute participation enabling demand flexibility and grid-support services. Processor nodes may autonomously respond to local grid events based on voltage, frequency, congestion, or power-quality signals. The plurality of processor nodes may collectively operate as a virtual distributed data center accessible to external compute markets.

In some aspects, scheduling decisions may include latency constraints, compute-type requirements, bandwidth availability, and performance compatibility. Economic dispatch decisions may incorporate predicted versus measured profitability for executed workloads. Workload routing and participation determination may be performed using machine learning.

In an exemplary method, heterogeneous processor nodes may be enabled to securely join a distributed compute mesh. Workloads may be received for distributed execution. For each processor node, a determination may be made whether to execute, migrate, defer, or reject a workload based on at least energy availability, power cost, operational capability, and expected execution performance. Future workload participation may be adjusted based on observed execution and energy outcomes.

In some aspects, the systems and methods described herein may be implemented as instructions stored on a non-transitory computer-readable medium that, when executed by a processor, cause a device to join the flexible edge computing mesh network, report available processing resources and energy status, receive and execute computational tasks assigned by the mesh network, and manage locally distributed energy resources to optimize energy consumption during task execution.

A number of implementations have been described. Nevertheless, it will be understood that various modifications may be made without departing from the spirit and scope of the disclosure. Accordingly, other implementations are within the scope of the following claims.

1. A system comprising:
a central controller communicatively coupled to a plurality of processor nodes forming a distributed compute mesh, wherein the central controller includes a memory storing a plurality of edge computing algorithms which, when executed by the central controller, cause the central controller to perform operations comprising:
receiving, in real-time, task data characterizing one or more compute workloads from a compute client,
receiving, in real-time, energy data characterizing local energy availability and energy pricing proximate the plurality of processor nodes and compute market pricing data characterizing compute market pricing proximate the plurality of processor nodes,
determining a predicted profitability and predicted operational suitability associated with executing the one or more compute workloads at each of the plurality of processor nodes based on the task data, the energy data, the compute data, and
routing the one or more compute workloads to one or more of the plurality of processor nodes having a highest predicted profitability or highest predicted operational suitability.

2. The system of claim 1, wherein the central controller is cloud based.

3. The system of claim 1, wherein the central controller further comprises a cloud-based component and one or more local controller components provided proximate to each of the plurality of processor nodes.

4. The system of claim 3, wherein each local controller component is configured to determine the predicted profitability and predicted operational suitability associated with executing the one or more compute workloads by a processor node of the plurality of processor nodes proximate the local controller component based on the task data, the energy data, the compute data.

5. The system of claim 4, wherein each local controller component is further configured to:
reject the one or more compute workloads responsive to the determining that the predicted profitability is negative or that the processor node proximate the local controller component does not have sufficient capacity.

6. The system of claim 4, wherein each local controller component is further configured to:
migrate the one or more compute workloads, by the prioritization algorithm, to another processor node of the plurality of processor nodes responsive to determining that the other processor node exhibits a higher the predicted profitability or has sufficient capacity.

7. The system of claim 4, wherein each local controller component is further configured to:
generate a set of priority rules for routing the one or more compute workloads, wherein the set of priority rules are generated based on the task data, the energy data, the compute data, performance of the processor node, and the predicted profitability and predicted operational suitability; and
update the set of priority rules dynamically based on observed execution performance by the processor node, a realized profitability, and a realized operational suitability.

8. The system of claim 3, wherein each local controller component is further configured to:
autonomously suspend exposure to the one or more compute workloads responsive to a local reliability condition, an energy scarcity event, or a grid flexibility signal, wherein suspended workloads are resumed when local or system-wide energy conditions improve.

9. The system of claim 3, wherein the processor node proximate each local controller component is configured to store the one or more compute workloads in a queue for later execution during periods of limited communication connectivity or capacity.

10. The system of claim 3, wherein each local controller component is further configured to:
receive attestation results from a secure enrollment mechanism of the processor node proximate the local controller component;
generate trust evaluations for processor node based on the attestation results; and
restrict or enhance future workload assignment the processor node based on the trust evaluations.

11. The system of claim 10, wherein each local controller component is further configured to:
restrict or enhance future workload assignment the processor node based on a capacity of the processor node.

12. The system of claim 3, wherein each local controller component is further configured to:
dynamically switch a state of the processor node proximate the local controller component between an active state in which the processor node is configured to execute the one or more compute tasks, an offloading state in which the processor node configured to offload the one or more compute workloads, and an inactive state in which the processor node is withdrawn from the distributed compute mesh.

13. The system of claim 3, wherein the task data is received from the compute client, via an external market interface.

14. The system of claim 13, wherein the plurality of processor nodes are aggregated into a unified compute pool that is exposed to external compute markets via the external market interface, enabling the distributed compute mesh to operate as a virtual distributed data center accessible to compute clients.

15. The system of claim 3, wherein each local controller component is further configured to:
receive processed compute workloads the processor node proximate the local controller component;
verify the processed compute workloads for accuracy and integrity;
provide training data to the plurality of edge computing algorithms, wherein the training data characterizes at least one of observed execution performance, realized profitability, and realized operational suitability associated with the processed compute workloads; and
provide the processed compute workloads to the compute client.

16. The system of claim 15, wherein the central processor is further configured to:
distribute compute-related compensation to owners of the plurality of processor nodes and operational partners based on the processed compute workloads.

17. The system of claim 1, wherein the plurality of processor nodes comprise any of CPUs, GPUs, neural accelerators, electric vehicle onboard compute systems, edge servers, IoT compute devices, and quantum accelerators.

18. The system of claim 1, wherein the task data further comprises data characterizing service level agreements (SLAs) for the one or more compute workloads.

19. The system of claim 18, wherein the central controller is configured to perform operations further comprising:
determining whether the one or more compute workloads should be executed using one or more of the plurality of processor nodes based on at least one of the task data, the energy data, the compute data, a capacity of the plurality of processor nodes, performance metrics of the plurality of processor nodes, and thermal conditions of the plurality of processor nodes.

20. The system of claim 19, wherein the task data further comprises workload classification data characterizing whether the one or more compute workloads are either time-critical or opportunistic, wherein the central controller is configured to determine whether the one or more compute workloads should be executed using one or more of the plurality of processor nodes based on the workload classification data.
